(19) United States
(12) Patent Application Publication
(10) Pub. No.: US 2015/0068852 A1
(43) Pub. Date: Mar. 12, 2015

(54) Wear Adjustment Device of a Disc Brake and Corresponding Disc Brake

(71) Applicant: KNORR-BREMSE Systeme fuer Nutzfahrzeuge GmbH, Muenchen (DE)

(72) Inventors: Ralf WEBER, Muenchen (DE); Thomas EICHLER, Muenchen (DE); Paul HABERL-GUENTHNER, Vilshofen (DE); Igor NESMJANOWITSCH, Hengersberg (DE)

(21) Appl. No.: 14/542,978

(22) Filed: Nov. 17, 2014

Related U.S. Application Data
(63) Continuation of application No. PCT/EP2013/060382, filed on May 21, 2013.

(30) Foreign Application Priority Data
May 18, 2012 (DE) 10 2012 009 900.2

(51) Int. Cl. F16D 65/52; F16D 65/42; B60T 1/06

(52) U.S. Cl. CPC F16D 65/52; B60T 1/065; F16D 65/42; F16D 2065/386
USPC 188/71.8; 188/196 C

(57) ABSTRACT

A wear adjustment device is provided for the adjusting friction surface wear on a brake pad and a brake disc of a disc brake having a brake application device, preferably with a rotary lever. The wear adjustment device can be coupled on the drive side to the brake application device, and on the output side to a spindle unit. A respective rolling body arrangement is axially arranged on both sides of a drive element, one of which is designed as a roller bearing and one is designed as a ball ramp coupling. A central shaft is coupled to the ball ramp coupling and has an output interface for coupling to the spindle unit. A radial freewheel is coupled to the ball ramp coupling by an overload spring unit and to the central shaft. A directionally-dependent torque device is provided, along with a housing in which the drive element, the rolling body arrangements, the overload spring unit, the radial freewheel, the central shaft and the directionally-dependent torque unit are arranged.

### CROSS REFERENCE TO RELATED APPLICATIONS

This application is a continuation of PCT International Application No. PCT/EP2013/060382, filed May 21, 2013, which claims priority under 35 U.S.C. §119 from German Patent Application No. 10 2012 009 900.2, filed May 18, 2012, the entire disclosures of which are herein expressly incorporated by reference.

### BACKGROUND AND SUMMARY OF THE INVENTION

The invention relates to a wear adjustment device of a disc brake, in particular for a motor vehicle. The invention also relates to a corresponding disc brake.

Vehicles and certain technical devices frequently use friction brakes, in order to convert kinetic energy. Here, the disc brake is preferred specifically in the passenger motor vehicle and in the commercial vehicle field. In the case of the typical construction of a disc brake, it consists of a brake caliper including inner mechanism, as a rule two brake pads and the brake disc. The cylinder forces are introduced to the inner mechanism via a pneumatically actuated cylinder, are boosted by way of an eccentric mechanism and are transmitted as brake application force via threaded spindles to the brake pads and the brake disc, the wear of the brake disc and brake pads being compensated for via the threaded spindles.

The brake application forces act via both brake pads on the brake disc, which experiences a retardation of the rotational movement depending on the level of the brake application force. This retardation is also significantly determined by the coefficient of friction between the brake disc and the brake pad. Since the pads are designed structurally as wear parts and the coefficients of friction are dependent on the strength, they are generally softer than the brake disc, that is to say the pads experience a change in the pad thickness over their service life, and they are subject to wear. This change in the pad thickness results in the necessity that a wear adjustment means compensates for the change and therefore sets a constant brake clearance. A constant brake clearance is required, in order to keep the response times of the brake low, to ensure the freedom of movement of the brake disc and to keep a stroke reserve for cases of critical loading.

DE 10 2004 037 771 A1 describes one example of a wear adjustment device. Here, a rotational drive movement is forwarded, for example, by a torque limiting device, for example having a ball ramp, via a continuously acting clutch (slip clutch) to an adjusting spindle of a pressure plunger. Here, the brake clearance is set continuously.

As described, wear is produced on the brake pads as a result of normal use, which wear has to be equalized via the wear adjustment device. In the case of the existing system, the problem lies in the fact that it functions on a frictional basis and therefore only within narrow limits or in a manner which is dependent on temperature and vibration, that is to say additional measures are necessary for brake clearance stabilization under the influence of temperature and vibration.

The object of the present invention consists in providing an improved wear adjustment device. It is a further object to provide an improved disc brake.

The object is achieved by way of a wear adjustment device according to the invention, and by way of a disc brake according to the invention.

A wear adjustment device is provided which has a compact construction in a housing and is, as far as possible, friction-independent and, as far as possible, functions in a positively locking manner.

A wear adjustment device is provided according to the invention for adjusting friction face wear on the brake pad and the brake disc of a disc brake, in particular for a motor vehicle, having a brake application device, preferably with a rotary lever. The wear adjustment device is coupleable on the drive side to the brake application device, preferably to the rotary lever, and on the output side to a spindle unit of the disc brake. In each case, one rolling body arrangement is arranged axially on both sides of a drive element, of which rolling body arrangements one is configured as an anti-friction bearing and one is configured as a ball ramp coupling. A central shaft is coupled to the ball ramp coupling and has an output interface for coupling to the spindle unit. A radial freewheel is coupled to the ball ramp coupling via an overload spring unit and to the central shaft. A direction-dependent torque device is provided. A housing houses the drive element, the rolling body arrangements, the overload spring unit, the radial freewheel, the central shaft and the direction-dependent torque device.

This results in a compact and space-saving construction which is situated in the housing. Moreover, the housing provides a protective function against moisture and dirt.

A disc brake according to the invention, preferably actuated by compressed air, in particular for a motor vehicle, having a brake application device, preferably having a brake rotary lever, at least one spindle unit and at least one wear adjustment device which is coupled to the brake application device, preferably to the brake rotary lever, has the wear adjustment device which is specified above.

It is provided in one embodiment that the direction-dependent torque device forms a vibration protection device. In this way, an integrated vibration stabilization device is formed.

To this end, it is provided, furthermore, that the wear adjustment device is configured by way of the direction-dependent torque device for discontinuous adjustment. An integrated temperature stabilization is thus also possible.

In one embodiment, the direction-dependent torque device comprises a moment ramp section which is connected fixedly to the central shaft, a moment ramp disc which is in engagement with the moment ramp section and an application moment spring which loads the moment ramp section and the moment ramp disc with an axial prestressing force which can be fixed in advance. Since the application operation is dependent on geometric variables, a positively locking function is made possible.

In a further embodiment, the application moment spring is arranged between a bottom section of the housing and the moment ramp disc. Small dimensions are possible as a result of this compact construction.

In a further embodiment, the direction-dependent torque device is configured with flat application ramps for adjustment and with adjusting ramps which are steep in relation to the flat application ramps for adjustment in the service case, which ramps are at least partially in contact. This results in high functionality in a very small space. The torque device can therefore perform a plurality of functions.

In a further embodiment, the axial bearing is formed from the drive element, axial bearing balls and a cover section of the housing. The housing therefore likewise has high functionality and reduces the number of components.

Another embodiment provides that the central shaft has a guide section which is fixed axially in the housing. The housing can therefore have a high functional integration.

A further advantage which is formed by the common housing lies in the fact that the axial bearing, the ball ramp coupling, the overload spring unit and the radial freewheel are arranged between the guide section and the cover section of the housing, which results in a considerable space saving.

In another embodiment, the radial freewheel is configured as a spring assembly and is in engagement with a freewheel toothing system of the central shaft. The radial freewheel can also have radially stacked spring arms. As a result, mutual support can be achieved in the locking direction, it being possible for a defined freewheel moment to be set in the release direction.

In a further embodiment, the housing is configured with at least one caliper anti-twist fixing device and/or one anti-twist fixing element. This results in a wide field of use in different brake configurations.

In a further embodiment, the ball ramp coupling has overload ramp balls which are positively guided in a ball cage and are arranged between the drive element and an overload ramp element. This results in a space-saving construction, the synchronization of said balls being made possible under different load cases.

A disc brake having two spindle units and a synchronizing unit can be configured in such a way that the wear adjustment device is inserted onto or into one of the two spindle units of the disc brake. This is possible by virtue of the fact that the wear adjustment device is configured both as an external design and as an internal design (in or around a threaded spindle).

The wear adjustment device according to the invention has the following advantages:
Integrated “vibration stabilization” (vibration resistance),
application dependent on geometric variables→positively locking,
as insensitive as possible to temperature,
application is discontinuous,
configuration in an external or internal design (in or around a threaded spindle),
functional moments can be set, and
considerably shorter overall design than the prior art.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a diagrammatic sectional view of one exemplary embodiment of a disc brake according to the invention;

FIGS. 2 and 2a are diagrammatic, perspective exploded illustrations of one exemplary embodiment of a wear adjustment device according to the invention from different viewing angles,

FIGS. 3 and 3a are diagrammatic, perspective illustrations of a component of the exemplary embodiment according to FIGS. 2 and 2a;

FIGS. 4 and 4a are diagrammatic, perspective illustrations of a component of the exemplary embodiment according to FIGS. 2 and 2a;

FIG. 5 is a diagrammatic, perspective illustration of a component of the exemplary embodiment according to FIGS. 2 and 2a;

FIGS. 6 and 6a are diagrammatic, perspective illustrations of a component of the exemplary embodiment according to FIGS. 2 and 2a;

FIGS. 7 and 7a are diagrammatic, perspective illustrations of a component of the exemplary embodiment according to FIGS. 2 and 2a;

FIGS. 8 and 8a are diagrammatic, perspective illustrations of a component of the exemplary embodiment according to FIGS. 2 and 2a;

FIGS. 9 and 9a are diagrammatic, perspective illustrations of a component of the exemplary embodiment according to FIGS. 2 and 2a;

FIGS. 10 and 10a are diagrammatic, perspective illustrations of a component of the exemplary embodiment according to FIGS. 2 and 2a;

FIG. 11 is a diagrammatic, perspective illustration of a central shaft having a radial freewheel;

FIG. 11a is a cross-sectional illustration of a plane of the radial freewheel;

FIG. 12 is a diagrammatic sectional view of ramps;

FIG. 13 is a diagrammatic sectional illustration of the wear adjustment device according to an embodiment of the invention;

FIG. 14 is a diagrammatic perspective view of the wear adjustment device in accordance with FIG. 13;

FIG. 15 is a diagrammatic sectional illustration of one variant of the wear adjustment device according to the invention;

FIG. 16 is a diagrammatic perspective view of the variant according to FIG. 15,

FIG. 17 is a diagrammatic part view of a second exemplary embodiment of the disc brake according to the invention;

FIG. 18 is an enlarged perspective view of the wear adjustment device in accordance with FIG. 13 on the disc brake according to FIG. 17, and

FIG. 19 is an enlarged perspective view of the wear adjustment device in accordance with FIG. 15 on the disc brake according to FIG. 17.

### DETAILED DESCRIPTION OF THE DRAWINGS

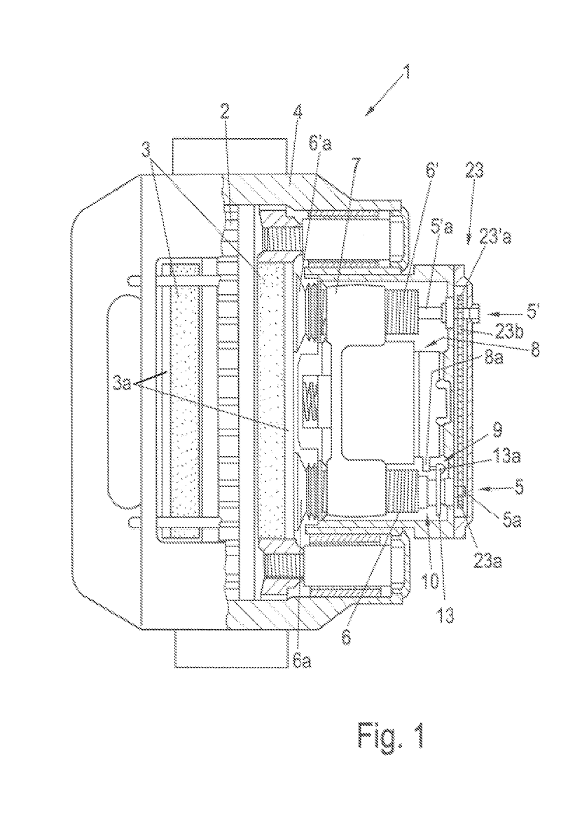

FIG. 1 shows a diagrammatic sectional view of one exemplary embodiment of a disc brake 1 according to the invention.

The disc brake 1 is shown here in an embodiment as a two-plunger brake with two spindle units 5, 5′ with threaded tubes 6, 6′. A brake caliper 4, configured here as a floating caliper, reaches over a brake disc 2, on which in each case one brake pad 3 with a brake lining carrier 3a is arranged on both sides. The application-side brake lining carrier 3a is connected to the spindle units 5, 5′ at ends of the threaded tubes 6, 6′ via pressure pieces 6a, 6′a. The other, reaction-side brake lining carrier 3a is fixed in the brake caliper 4 on the other side of the brake disc. The threaded tubes 6, 6′ are arranged rotatably in each case in a crossmember (bridge) 7. The crossmember 7 and therefore the threaded tubes 6, 6′ can be actuated by a brake application device (here, a rotary lever 8 with a pivot axis at a right angle with respect to the rotational axis) of the brake disc 2. Here, the wear adjustment device 10 is inserted into the spindle unit 5 of the two spindle units 5, 5′ on an adjuster shaft 5a. The adjuster shaft 5a is coupled via a synchronizing device 23 to a driver shaft 5′a which is inserted into the other spindle unit 5′. Here, the synchronizing device 23 comprises a synchronizing wheel 23a (here, a chain sprocket) on the application-side end of the adjuster shaft 5a of the wear adjustment device 10, a synchronizing wheel 23′a (here, a chain sprocket) on the corresponding end of the driver shaft 5′a, and a synchronizer 23b (here, a chain). In this way, a synchronous movement of the spindle units 5 and 5′ is ensured during wear adjustment operations.

The wear adjustment device 10 interacts with the rotary lever 8 via a drive 9. The drive 9 comprises an actuator 8a which is connected to the rotary lever 8, and an operating lug 13a of a drive element 13 of the wear adjustment device 10.

A spacing between the brake pads 3 and the brake disc 2 is called a brake clearance. Said brake clearance becomes greater as a consequence of pad and disc wear. If this is not compensated for, the disc brake 1 cannot reach its peak performance, since an actuating stroke of the actuating mechanism (that is to say, the actuating stroke or a pivoting angle of the rotary lever 8 here) is no longer sufficient.

The disc brake 1 can have different power drives. Here, the rotary lever 8 is actuated, for example, pneumatically. Reference is made to the corresponding description of DE 197 29 024 C1 with respect to the construction and function of a pneumatic disc brake 1.

The wear adjustment device 10 according to the invention, which will be described in detail further below, is configured for wear adjustment of a previously fixed brake clearance which is called the nominal brake clearance. The expression “adjustment” is to be understood to mean a reduction in the brake clearance. The previously fixed brake clearance is defined by the geometry of the disc brake 1 and has what is known as a structural brake clearance. In other words, the wear adjustment device 10 reduces an existing brake clearance when the latter is too large in relation to the previously fixed brake clearance.

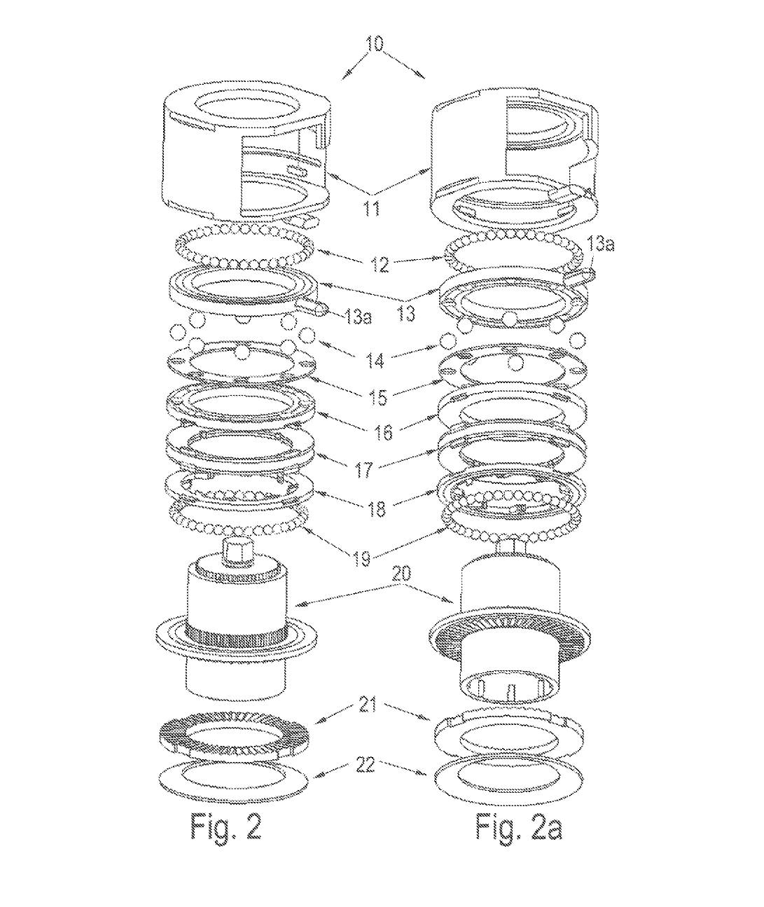

FIGS. 2 and 2a show diagrammatic, perspective exploded illustrations of one exemplary embodiment of the wear adjustment device 10 according to the invention from different viewing angles.

The wear adjustment device 10 comprises a housing 11, axial bearing balls 12, the drive element 13 with the operating lug 13a, overload ramp balls 14 with a ball cage 15, an overload ramp element 16, an overload spring unit 17, a radial freewheel 18, freewheel balls 19, a central shaft 20, a moment ramp disc 21 and an application moment spring 22.

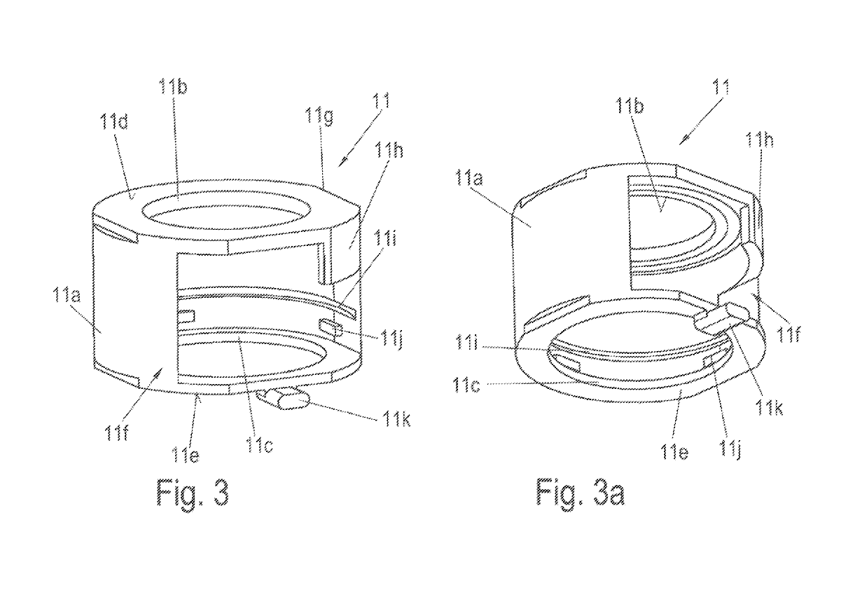

The functional components of the wear adjustment device 10 of the exemplary embodiment according to FIGS. 2 and 2a will now be described in conjunction with diagrammatic, perspective illustrations of the components of FIGS. 3 to 10.

The expression upper side is to be understood to mean that side of the respective component which points toward the brake application side in the installed state in the disc brake 1. The underside of the respective component then points toward the brake disc 2.

FIGS. 3 and 3a show the housing 11. It has a substantially hollow-cylindrical body with a circumferential wall 11a which is interrupted on approximately one quarter of the circumference of a wall opening 11f and is covered at the top by way of a cover section 11d with a circular opening 11b. A bottom section 11e which lies parallel to the cover section 11d and likewise has a circular opening 11c is arranged on the underside of the housing 11. The housing 11 is flattened on one side adjacently with respect to the wall opening 11f, a caliper rotational fixing structure 11g being formed, by way of which the wear adjustment device 10 can be fixed such that it cannot rotate via the housing 11 in the brake caliper 4.

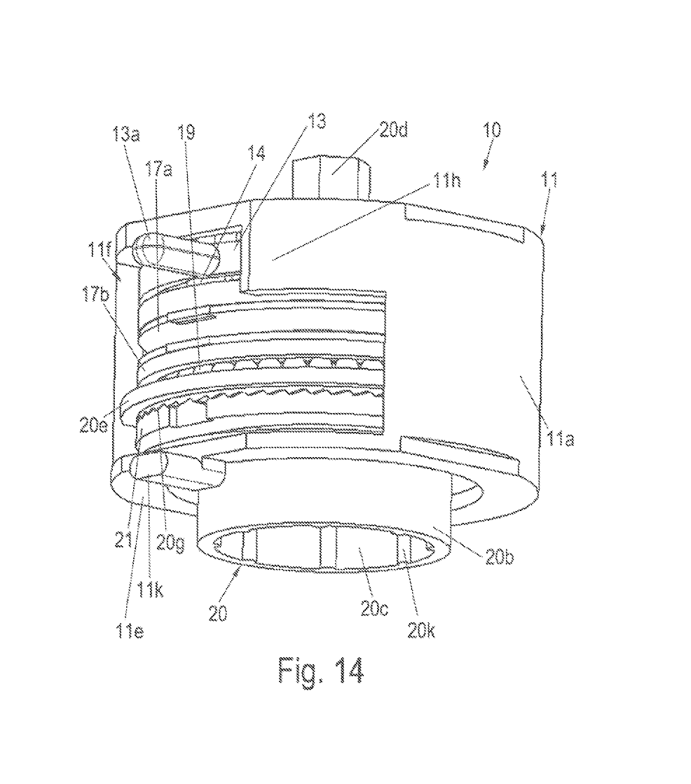

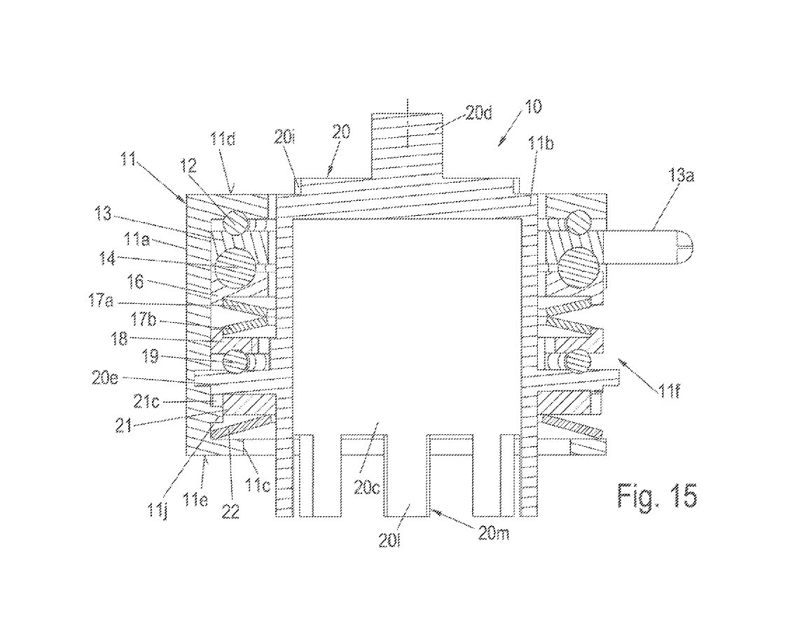

Here, the wall opening 11f is closed partially on its right-hand side (here, in the upper right quarter) by way of a stop 11h for the operating lug 13a (see also FIG. 14).

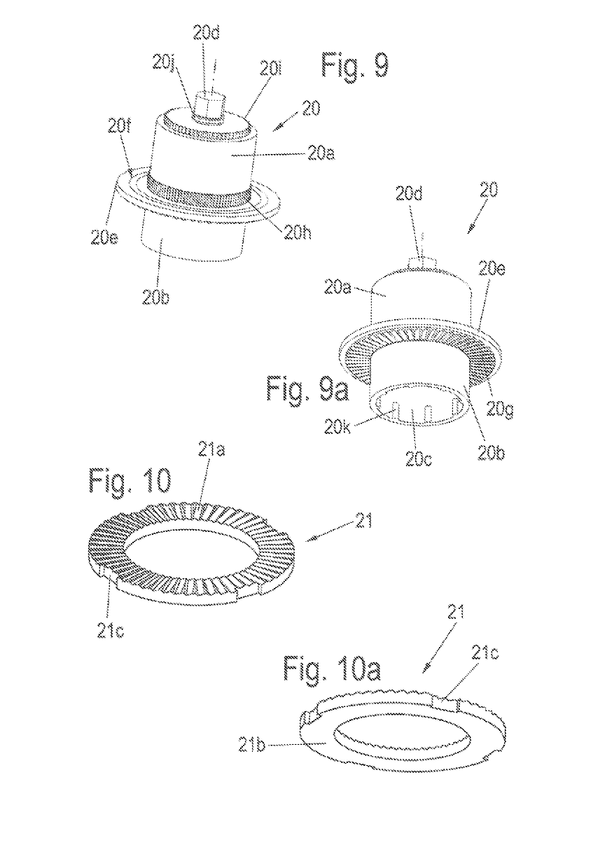

A guide groove 11i, which serves to receive a guide section 20e (FIGS. 9; 13) of the central shaft 20, is formed on the inner side of the wall 11a within the housing 11. Anti-twist securing elements 11j in the form of elongate projections which extend in the circumferential direction are formed below the guide groove 11i on the inner side of the wall 11a. In interaction with securing groove 21c, the anti-twist securing elements 11j serve for the anti-twist fixing of the moment ramp disc 21 (see FIG. 10) in the housing 11.

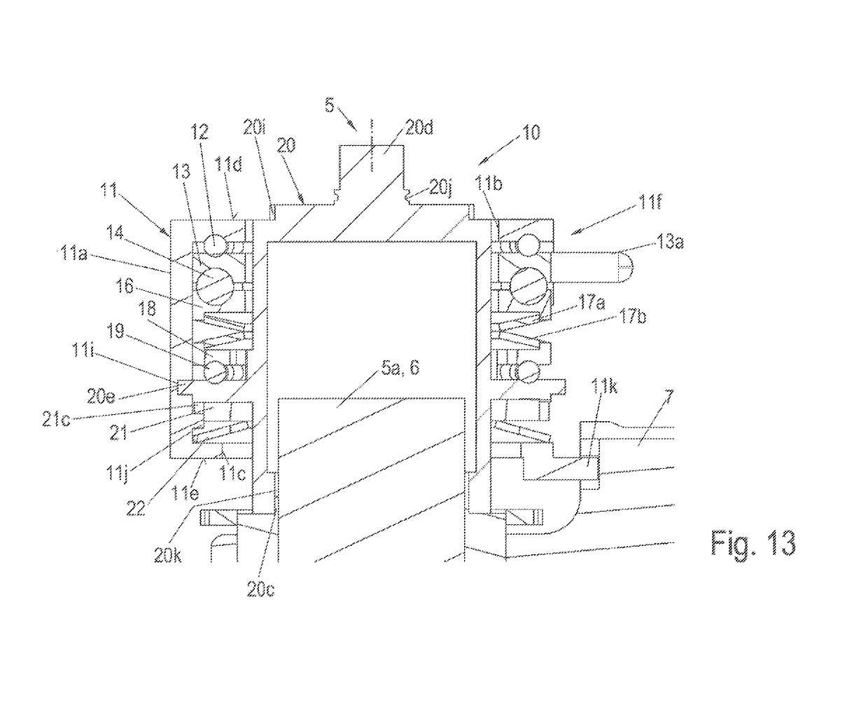

An axial bearing raceway (not denoted in greater detail) for the axial bearing balls 12 is formed on the inner underside of the cover section 11d (see also FIG. 13).

Finally, a radially outwardly extending anti-twist fixing element 11k in tongue form is formed on the lower bottom section 11e below the wall opening 11f. It serves for the anti-twist securing of the housing 11 in a corresponding receptacle of the crossmember 7 (see FIGS. 13; 17; 18).

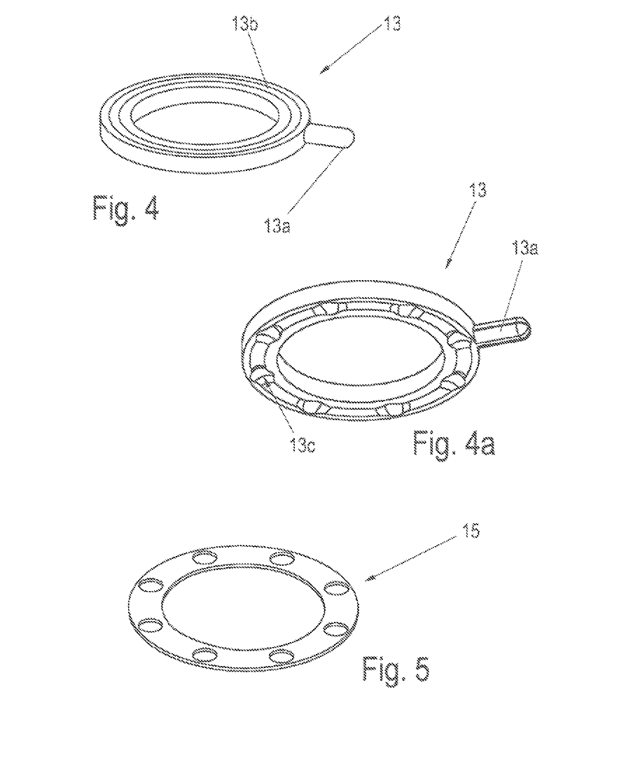

The drive element 13 is shown in FIG. 4 and FIG. 4a. It has an annular body, through which the operating lug 13a is attached in pin form. The operating lug 13a extends radially to the outside from the outer circumference of the annular body. An axial bearing raceway 13b for the axial bearing balls 12 is formed into the upper side of the annular body of the drive element 13 (FIG. 4). In addition, an overload ramp raceway 13c for the overload ramp balls 14 is formed into the underside of the drive element 13, which underside is shown in FIG. 4a.

FIG. 5 shows the ball cage 15 which is provided here for eight overload ramp balls 14. It can of course be configured to have more or fewer overload ramp balls 14.

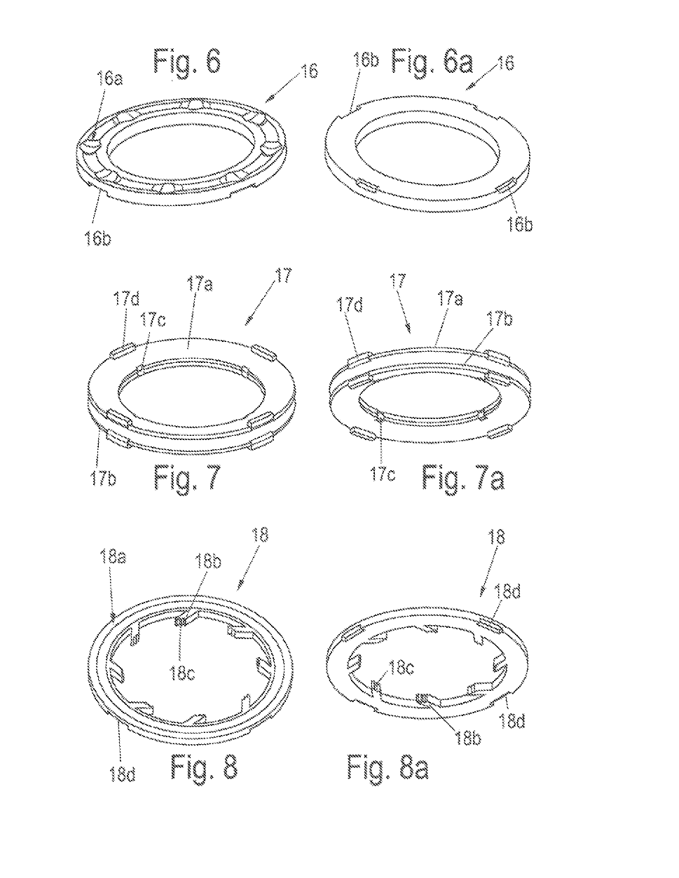

FIGS. 6 and 6a show the overload ramp element 16. It is of annular configuration and has an overload ramp raceway 16a (corresponding to the overload ramp raceway 13c) for the overload ramp balls 14 on its upper side (FIG. 6). Here, four spring fixing grooves 16b which serve to fix the overload spring unit 17 (FIGS. 7-7a) are formed on the border circumference of the underside (shown in FIG. 6a) of the overload ramp element 16.

The overload spring unit 17 is shown in FIG. 7 and FIG. 7a and, here, comprises two springs 17a and 17b which are arranged with their inner openings on one another and are configured as disc springs. The overload spring unit 17 is configured as a spring assembly, the two disc springs being connected to one another at their inner openings via assembly connections 17c. The springs 17a and 17b are provided in each case with four fixing projections 17d on the outer circumferential edges. The fixing projections 17d of the upper spring 17a are provided for interaction with the spring fixing grooves 16b of the overload ramp element 16. The fixing projections 17d of the lower spring 17b interact with the radial freewheel 18 which is shown in FIG. 8 and FIG. 8a.

The radial freewheel 18 which is shown with its underside in FIG. 8 and with its upper side in FIG. 8a is likewise of annular design. A freewheel axial bearing raceway 18a for the freewheel balls 19 is formed on its underside. Here, eight freewheel springs 18b, which extend radially obliquely to the inside and have a profiling 18c at their free ends, are formed on the edge of the circumference of the inner opening of the radial freewheel 18. Here, the profiling 18c is of toothed configuration and is provided for interaction with a freewheel toothing system 20h of the central shaft 20 (see FIGS. 9; 11 and 11a). Here, four spring fixing grooves 18d for fixing the fixing projections 17d of the lower spring 17b of the overload spring unit 17 are formed at the outer circumferential edge of the upper side of the radial freewheel 18 (FIG. 8a).

FIG. 9 shows the central shaft 20 as viewed from its upper side. A view from the underside of the central shaft 20 is shown in FIG. 9a. In this exemplary embodiment, the central shaft 20 is a hollow cylinder with a circular cross section. The hollow cylinder has an upper drive section 20a and a lower output section 20b with an output interface 20c with output elements 20k on the inner wall. The drive section 20a is closed on its upper side and is provided with a disc-like toothed rim which has a sensor toothing system 20i. Here, a hexagonal journal is attached centrally on the closed upper side of the drive section 20a of the central shaft 20 as adjusting interface 20d in the axial direction. The adjusting interface 20d serves to attach a tool, for example a hexagon key, for manual adjustment of the wear adjustment device 10, which will be explained in greater detail below. A sealing ring groove 20j for receiving a sealing ring, for example a round section sealing ring (O-ring), is formed at the transition point between the hexagonal journal and the drive section 20a in order to seal with respect to the brake caliper 4.

The two sections 20a and 20b are divided by way of a disc-like guide section 20e, the external diameter of which in this example is approximately a third greater than the external diameter of the two sections 20a and 20b. Moreover, the external diameter of the guide section 20e is greater than the internal diameter of the housing 11 (see FIG. 13), installation taking place through the wall opening 11f.

On its annular upper side, the guide section 20e is provided with a freewheel axial bearing raceway 20f for the freewheel balls 19, a moment ramp section 20g for interaction with the moment ramp disc 21 according to FIGS. 10 and 10a being formed in and/or on the underside of the guide section 20e.

The output interface 20c serves for connection to an upper end of the adjuster shaft 5, which upper end has axial grooves which correspond with the output elements 20k. The assembled wear adjustment device 10 can thus be placed onto the adjuster shaft 5a in a rotationally fixed manner, which will be described further below.

FIG. 10 shows the upper side of the moment ramp disc 21 and FIG. 10a shows its underside. The moment ramp disc 21 is of annular design and is provided on its upper side with moment ramps 21a which interact with the moment ramp section 20g of the central shaft 20. Here, four securing grooves 21c which are continuous from the underside to the upper side and interact with the anti-twist securing elements 11j on the inner side of the wall 11a of the housing 11 are formed on the outer circumference of the moment ramp disc 21.

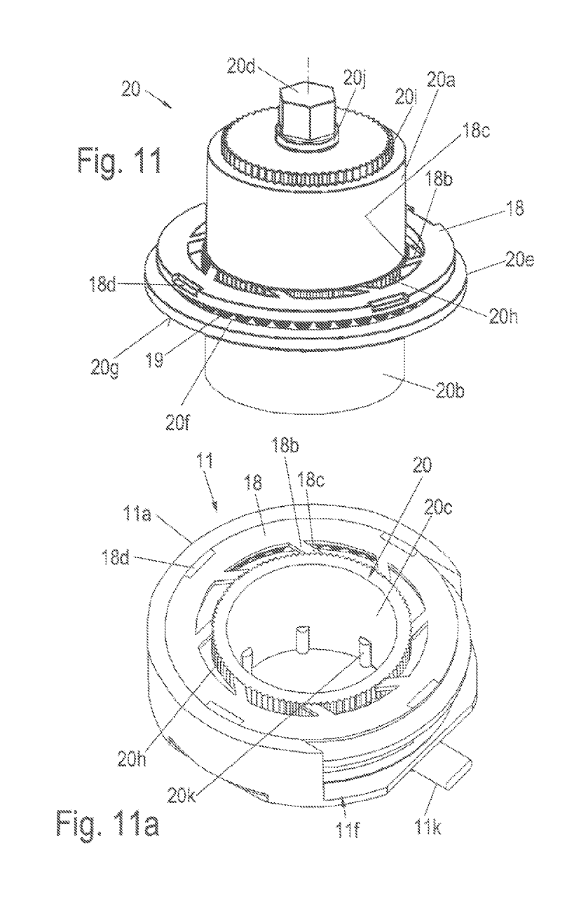

FIG. 11 shows a diagrammatic, perspective illustration of the central shaft 20 with the radial freewheel 18. FIG. 11a shows a cross-sectional illustration of a plane of the radial freewheel 18.

The freewheel balls 19 are arranged on the freewheel axial bearing raceway 20g of the guide section 20e and support the radial freewheel 18. The radial freewheel 18 is placed onto the freewheel balls 19 via the drive section 20a of the central shaft 20 in such a way that the profilings 18c of the freewheel springs 18b are in engagement with the teeth of the freewheel toothing system 20h of the central shaft 20.

A plan view of said arrangement on the upper side of the radial freewheel 18 in the installed state in the housing 11 can be seen in the cross-sectional illustration according to FIG. 11a. It can be seen here that the wall opening 11f is dimensioned to be so large that the central shaft 20 can be inserted with guide section 20e through the wall opening 11f into the guide groove 11i (not visible here), as a result of which the central shaft 20 with the functional components which are arranged on and around it is fixed axially in the housing 11.

Here, the freewheel springs 18b are arranged in an angled manner such that a rotational movement of the central shaft 20 (about its longitudinal axis which is not shown but is readily conceivable) is possible here in the plan view in the clockwise direction relative to the radial freewheel 18. In the counterclockwise direction, the central shaft 20 and the radial freewheel 18 are connected in a positively locking manner and fixedly so as to rotate with one another via the profilings 18c of the freewheel springs 18b, which profilings 18c are in engagement with the freewheel toothing system 20h, with the result that no relative rotational movement is possible between the central shaft 20 and the radial freewheel. The further functions of the radial freewheel 18 in conjunction with the wear adjustment device 10 will be described in detail further below.

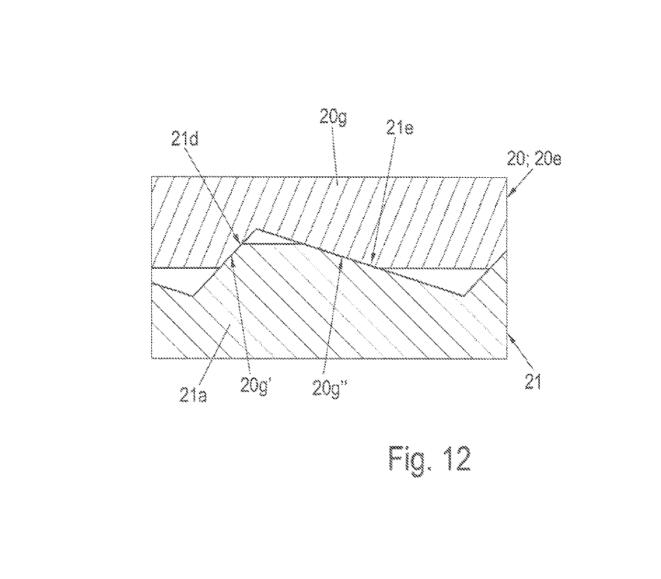

FIG. 12 shows a diagrammatic sectional view of ramps of the ramp section 20g of the guide section 20e of the central shaft 20 in the assembled state in interaction with the moment ramps 21a of the moment ramp disc 21. The ramp section 20g of the central shaft 20 is in engagement with the moment ramps 21a of the moment ramp disc 21, steep ramps and less steep ramps being in contact with one another in such a way that steep adjusting ramps 21d of the moment ramp disc 21 bear against steep adjusting ramps 20g′ of the central shaft 20, and that less steep application ramps 21e of the moment ramp disc 21 bear against less steep adjusting ramps 20g″ of the central shaft 20. Here, the ramps bear in each case only partially against one another. For example, the adjusting ramps 21d and 20g′ bear against one another approximately only over half of their ramp lengths in the region of their head sides. In the illustration in FIG. 12, the ramps form a type of tooth profile in section. The function of the different gradients of the ramps will be explained further below.

FIG. 13 shows a diagrammatic sectional illustration of the wear adjustment device 10 according to the invention, and FIG. 14 shows a diagrammatic perspective view of the wear adjustment device according to the invention in accordance with FIG. 13.

The central shaft 20 is inserted in the housing 11 in such a way that the upper side of the drive section 20a with the adjusting interface 20d protrudes through the opening 11b of the cover section 11d of the housing 11, and the cover section 11d of the housing 11 is flush with the upper side of the drive section 20a. The output section 20b extends through the opening of the bottom section 11e of the housing 11. The functional components of the wear adjustment device 10 are arranged in the housing 11 in the following order starting from the top.

An axial bearing is formed with the axial bearing balls 12 between the underside of the cover section 11d of the housing and the upper side of the drive element 13. The underside of the drive element 13 lies on the overload ramp balls 14 which are held in the ball cage 15 and are guided on the upper side of the overload element 16. The underside of the overload element 16 lies on the upper spring 17a of the spring unit 17 and is coupled fixedly to it so as to rotate together via the fixing projections 17d in the spring fixing grooves 16b. The lower spring 17b lies on the upper side of the radial freewheel 18 and is connected fixedly to the latter so as to rotate with it via its fixing projections 17d in the spring fixing grooves 18d of said radial freewheel 18. The radial freewheel 18 lies with its underside on the freewheel balls 19 which for their part are guided on the upper side of the guide section 20e of the central shaft 20. The freewheel springs 18b (also called spring assemblies here) are in engagement with the freewheel toothing system 20h of the central shaft 20, as has already been described above.

The guide section 20e is received in the guide groove 11i of the housing 11. The moment ramp disc 21 is arranged below the guide section 20e and is in engagement by way of the moment ramps 21a of its upper sides with the moment ramp section 20g of the guide section 20e of the central shaft 20 as a result of spring force of the application moment spring 22. The application moment spring 22 is arranged between the underside of the moment ramp disc 21 and the inner side of the bottom section 11e of the housing and thus exerts an axial prestress against the moment ramp disc 21 as a result of support on the bottom section 11e. The moment ramp disc 20g is secured fixedly in the housing 11 so as to rotate with it, but can be displaced axially, via the engagement of the anti-twist securing elements 11j of the inner side of the housing 11 in the securing grooves 21c, since the securing grooves 21c are formed on the circumferential edge of the moment ramp disc 20g in an axially continuous manner from the upper side to the underside.

In FIG. 13, the wear adjustment device 10 is placed with the output interface 20c on the upper end of the adjusting shaft 5a or a threaded tube 6 and is coupled fixedly to the adjusting shaft 5a so as to rotate with it via the output elements 20k. With respect to the crossmember 7, the wear adjustment device 10 is fixed against rotation by way of the anti-twist fixing element 11k in a receptacle which is not denoted in greater detail.

FIG. 14 shows the wear adjustment device 10 as viewed perspectively from below; the stop 11h can be seen clearly in the wall opening 11f. The stop 11h lies in the pivoting plane of the operating lug 13a. The stop 11h serves as a stop for the operating lug 13a, it being possible for said operating lug 13a to be pivoted between the left-hand upper edge of the wall opening 11f and the stop 11h (can be seen clearly in FIG. 14) about a longitudinal axis of the housing 11 and therefore about a longitudinal axis (not shown, but readily conceivable) of the wear adjustment device 10. The housing 11 accommodates all the functional components of the wear adjustment device 10 in a compact overall design and protects them correspondingly.

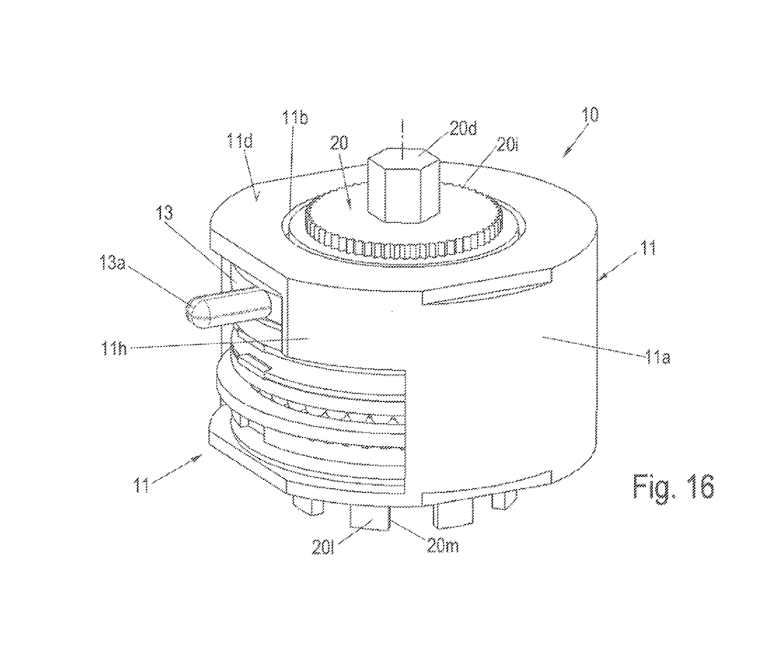

FIG. 15 shows a diagrammatic sectional illustration of one variant of the wear adjustment device 10 according to the invention, and FIG. 16 shows a diagrammatic perspective view of the variant according to FIG. 15.

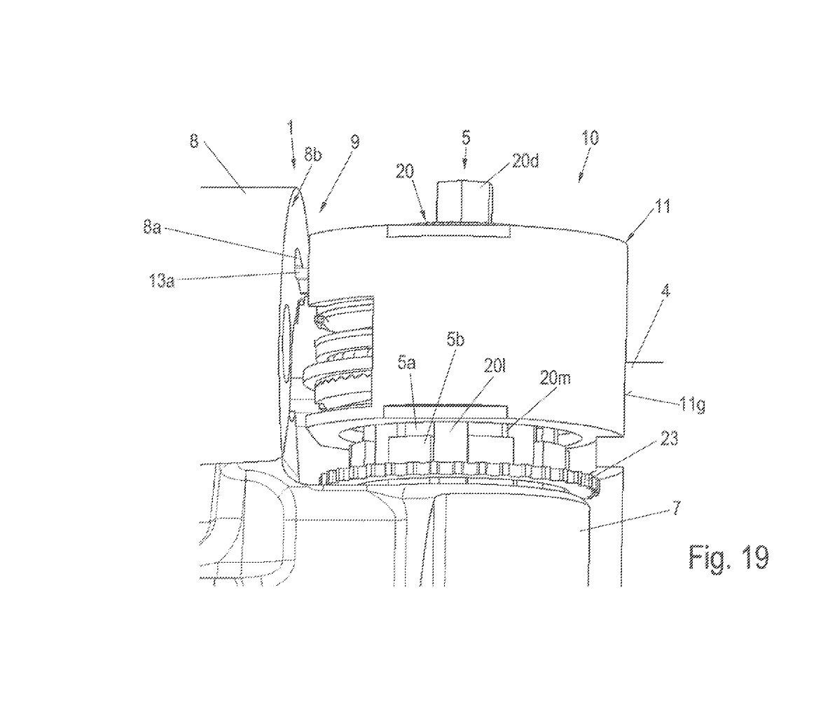

The variant according to FIG. 15 differs from the embodiment according to FIG. 13 in that the housing 11 does not have an anti-twist fixing element 11k. An anti-twist securing structure consists in that the caliper anti-twist fixing structure 11g interacts with associated faces on the brake caliper 4 for anti-twist securing in the installed state of the wear adjustment device 10 (see FIG. 19).

A further difference of said variant according to FIG. 15 with respect to the embodiment according to FIG. 13 lies in the fact that the output interface 20c is configured with axial output tongues 201 with axial output edges 20m and with axial recesses which lie between the output tongues 201. The associated adapted end of the adjusting shaft 5a is not shown, but is readily comprehensible. It is provided with axial grooves, into which the output tongues 201 are pushed when the wear adjustment device 10 is placed onto the adjusting shaft 5a.

The construction of the functional components of the variant according to FIG. 15 of the wear adjustment device 10 in the housing 11 corresponds to the construction which is described in conjunction with FIG. 13.

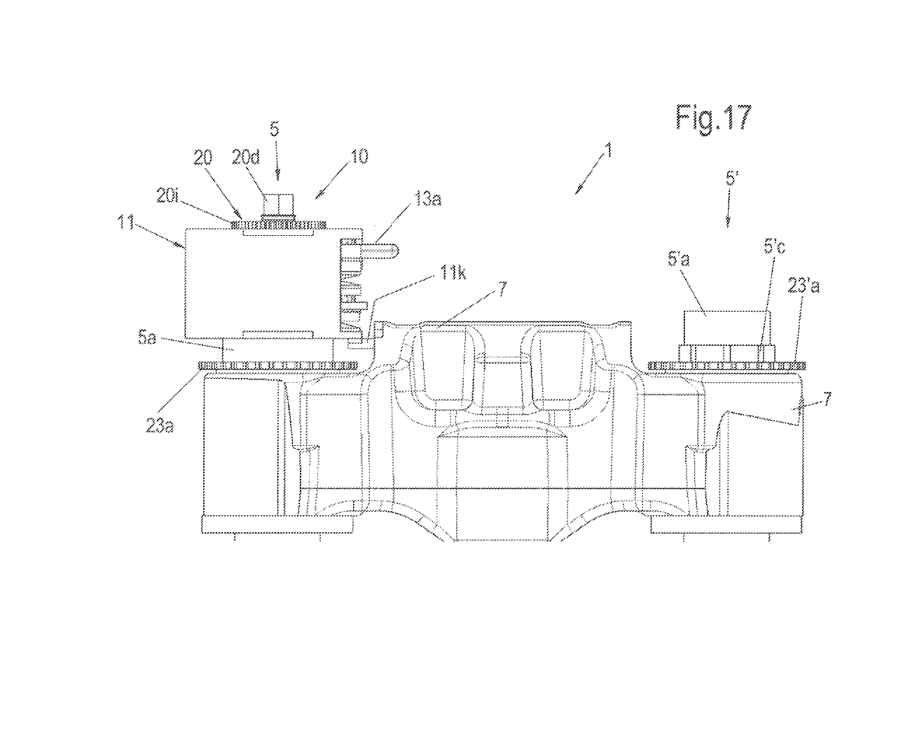

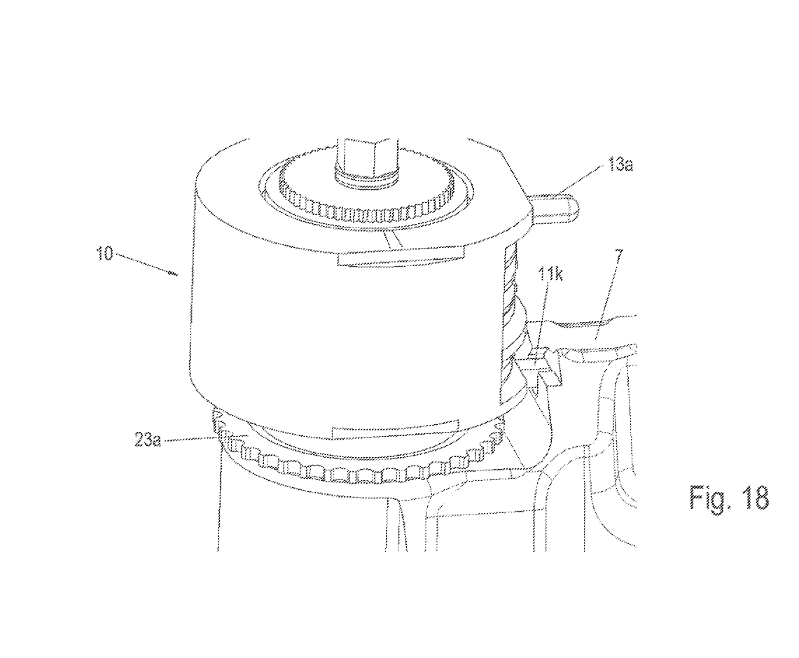

FIG. 17 shows a diagrammatic partial view of a second exemplary embodiment of the disc brake 1 according to the invention, and FIG. 18 shows an enlarged perspective view of the wear adjustment device 10 according to the invention in accordance with FIG. 13 on the disc brake 1 according to FIG. 17. In said second exemplary embodiment, the wear adjustment device 10 is not inserted in the spindle unit 5, but rather is placed on the end of the adjusting shaft 5a of the spindle unit 5. The wear adjustment device 10 in the embodiment according to FIG. 13 is placed onto the end of the adjusting shaft 5a and the anti-twist fixing element 11k is received in the crossmember 7. The adjusting shaft 5a has a chain sprocket as synchronizing wheel 23a. Furthermore, the end of the driver shaft 5′a with the synchronizing wheel 23′a and axial grooves 5′c for the output elements 20k is shown. The wear adjustment device 10 can be placed both onto the adjusting shaft 5a and onto the driver shaft 5′a. Instead of chain sprockets as synchronizing wheels 23a, 23′a, other gearwheels (spur gears, bevel gears or the like) can of course also be used, for example.

Finally, FIG. 19 shows an enlarged perspective view of the wear adjustment device 10 according to the invention in the variant according to FIG. 15 attached to the disc brake 1 according to FIG. 17. The output tongues 201 of the output interface 20c of the wear adjustment device 10 engage into axial grooves of a profile 5b of the end of the adjusting shaft 5a. The caliper anti-twist fixing structure 11g forms an anti-twist securing structure of the wear adjustment device 10.

Furthermore, FIG. 19 shows the drive 9 by way of example. The operating lug 16a is in engagement with the actuator 8a which is configured here as a groove in a body 8b which is connected to the rotary lever 8. The structural brake clearance can be fixed, for example, by way of the groove of the actuator 8a.

The following functional areas which will be explained in the following text can be realized by way of the described wear adjustment device 10 according to the invention.

1. Nominal brake clearance setting
2. Brake clearance adjustment
3. Overload case
4. Service case

### 5. Miscellaneous

1. Nominal Brake Clearance Setting

The nominal brake clearance corresponds to the structural brake clearance, and is realized via the operating lug 13a on the overload ramp raceway 13c and an associated structurally set play with respect to the actuator 8a (see also FIGS. 14 and 19), which is not to be described in further detail here. Here, the method of operation is such that the adjusting mechanism of the wear adjustment device 10 is not driven within the structural brake clearance up to a defined actuating angle of the actuator 8a.

2. Brake Clearance Adjustment

In the operating case when the existing brake clearance is greater than the nominal brake clearance, an adjusting operation occurs after bridging of the structural brake clearance. Here, the drive element 13 is driven via the operating lug 13a by the actuator 8a and is rotated in the application direction. Here, the application direction is to be understood to mean the rotational direction which is necessary, in order to adjust the brake pads 3 toward the brake disc 2. Here, in conjunction with FIGS. 11 and 11a, the application direction is the rotational direction in the clockwise direction.

There is a positively locking connection via the overload ramp balls 14 to the overload ramp element 16, there is a positively locking connection from the latter to the overload spring unit 17, there is a positively locking connection from the latter to the radial freewheel 18, there is a positively locking connection from the latter to the central shaft 20 by way of blocking of the radial freewheel 18 via the freewheel springs 8b which form a positively locking connection with the freewheel toothing system 20h of the central shaft 20, and there is a positively locking connection from said central shaft 20 to the adjusting shaft 5a or threaded spindle 6 via the output interface 20c.

The moment ramps of the moment ramp section 20g are situated on the central shaft 20, which moment ramps operate counter to the application moment spring 22 and the moment ramp disc 21 which is secured against rotation with respect to the housing 11 via anti-twist securing elements 11j and securing grooves 21c. The moment ramp disc 21 has two ramps with gradients which are different from one another, as shown in FIG. 12. These are the application ramps 21e and the adjusting ramp 21d which can also be called the service ramp. Said ramps generate a direction-dependent torque as a result of the prestress of the application moment spring 22. In the case of a rotation in the application direction (in FIG. 12, the moment ramp section 20g then moves to the left, the moment ramp disc 21 being fixed), the moment ramp disc 21 is displaced axially counter to the application moment spring 22 (downward in FIG. 12) via the flat application ramp 21e as a result of the contact of the application ramp 20g″ of the moment ramp section 20g; the tooth profile has to jump into the next tooth for a permanent reduction in brake clearance, it being necessary for a defined rotary angle and a defined axial displacement to be overcome, and the “application moment” being generated which acts between the adjusting shaft 5a (spindle) and the housing 11.

In this way, a direction-dependent torque device is formed which has the moment ramp section 20g, the moment ramp disc 21 and the application moment spring 22.

The smallest possible application amount is defined by the pitch of the teeth of the moment ramp section 20g on the corresponding tooth diameter and the thread pitch which is used, the overall magnitude of the brake clearance reduction is dependent on the pivoting angle of the drive element 13 and/or on the pivoting angle of the actuating mechanism, for example of the rotary lever 8 and the actuator 8a. As a result, disturbance variables which act on the system from the outside have to overcome the “application moment” for a permanent brake clearance reduction, which “application moment” therefore corresponds to a “vibration securing moment” which can also be called “vibration resistance”.

When the disc brake 1 is relieved or the drive element 13 pivots back into the starting position, the brake clearance reduction is maintained as a result of the release of the radial freewheel 18 (see FIGS. 11 and 11a). The starting position is defined unambiguously by way of the stop 11h which is integrated into the housing 11.

3. Overload Case

When the adjusting operation is ended or the nominal brake clearance is present and the threaded spindles 6, 6′ bear against the brake pads 3/brake lining carriers 3a, further rotation of the drive element 13 in the application direction occurs during the application of the brake application force as a result of elasticities in the brake system, but the threaded spindles are blocked against rotation. The central shaft 20 is likewise blocked as a result of the positively locking connection of the threaded spindles 6, 6′ (or the adjusting shaft 5a/driver shaft 5′a which is coupled thereto) to the central shaft 20.

However, the drive element 13 is rotated further, as a result of which a torque is applied by the overload ramp balls 14, the overload ramp element 16, the overload spring unit 17, and the radial freewheel 18, but rotation does not occur as a result of the blocked radial freewheel 18. The overload ramp balls 14 run in the ramp profile of the overload ramp raceway 13c of the drive element 13 and the overload ramp element 16 and bring about axial displacement of the overload ramp element 16 counter to the overload spring unit 17 which is compressed.

When the disc brake 1 is released and/or the drive element 13 is rotated back, the radial freewheel moment of the radial freewheel 18 has to be so great that the overload ramp balls 14 are pivoted back into the starting position again. The integrated stop 11h in the housing 11 ensures that the structural brake clearance is maintained between the operating lug 13a and the actuator 8a.

4. Service Case

The service case comprises the replacement of the brake pads 3 when they are worn; here, the threaded spindles 6, 6′ are extended to their maximum and have to be reset into the starting position. Here, a rotation is applied at the adjusting interface 20d of the central shaft 20 for adjusting of the adjuster in the opening direction (counter to the application direction). Since the central shaft 20 is connected via the output interface 20c in a positively locking manner to the threaded spindle 6, 6′ (and/or adjuster shaft 5a and synchronizing device 11 to the driver shaft 5′a), the rotational movement is transmitted directly to the threaded spindles 6, 6′.

Here, the moment ramp section 20g of the central shaft 20 is rotated with the adjusting ramp 20g′ against the adjusting ramp 21d (service ramp) of the moment ramp disc 21 (see FIG. 12), and the moment ramp disc 21 is displaced axially counter to the application moment spring 22 because the central shaft 20 is fixed axially in the housing 11 via the guide section 20e in the guide groove 11i. A “ramp restoring moment” is generated.

The rotation of the central shaft 20 is transmitted to the overload ramp balls 14 via the blocked radial freewheel 18, the positively locking connection to the overload spring unit 17 and the positively locking connection to the overload ramp element 16. The drive element 13 is locked against rotation in the opening direction via the integrated stop 11h of the housing 11, and the overload ramp balls 14 run onto the ramp profile of the overload ramp raceway 13c of the drive element 13 and the overload ramp raceway 16a of the overload ramp element 16 and displace the overload ramp element 16 axially counter to the overload spring unit 17, and an “overload restoring moment” is generated.

The sum of the two torques “ramp restoring moment” and “overload restoring moment” results in the “service moment” which has to be overcome in order to restore the system (via the adjusting or service interface 20d).

5. Miscellaneous

The overload ramp balls 14 are positively guided by way of the ball cage 15, in order to ensure synchronization of the overload ramp balls 14 under different load cases.

The radial freewheel 18 consists of radially stacked spring arms, in order to achieve mutual support in the blocking direction. The corresponding contour on the central shaft 20 is configured as a freewheel toothing system 20h, in which the spring arms are supported in the blocking direction and a defined freewheel moment is set in the release direction.

The sealing ring groove 20j, into which an O-ring or a diaphragm can be mounted depending on the type of embodiment, is introduced on the central shaft 20 below the adjusting interface 20d (hexagonal journal).

A toothing system is attached to the central shaft 20 as sensor toothing system 20i for wear potentiometer tapping, via which toothing system the wear can be detected, for example, by use of a rotary angle sensor in a manner which is offset axially with respect to the adjuster line of action. The diameter of the sensor toothing system 20i is adapted to a wear sensor planetary gear mechanism.

The wear adjustment device is designed as a ramp wear adjuster primarily for the wear adjustment for pneumatically applied disc brakes in the commercial vehicle field, but can also be used in all other applications where wear compensation is necessary.

The wear adjustment device 10 can be configured both in an external design and in an internal design. An external design is to be understood to mean that the wear adjustment device 10 can be placed around a threaded spindle 6, 6′ of a spindle unit 5, 5′ or can be placed onto said threaded spindle 6, 6′. An internal design means that the wear adjustment device 10 can be inserted into a spindle unit 5, 5′, for example into a threaded spindle 6, 6′ as in the first exemplary embodiment of the disc brake 1 according to FIG. 1.

The above-described exemplary embodiments do not restrict the invention which can be modified within the scope of the appended claims.

It is thus conceivable, for example, that compression spring systems, elastomer systems or variations can also be used instead of the described disc spring systems (overload spring unit 17 and application moment spring 22).

The described ramp systems in the overload ramp raceways 13c and 16a can be varied freely in terms of the configuration of the ramp raceway and the number of hollows.

The gradients and pitches of the described moment ramps 20g′, 20g″ of the moment ramp section 20g of the central shaft 20 and the adjusting ramps 21d and application ramps 21e of the moment ramps 21a can be varied freely.

Instead of the described radial freewheel 18, all freewheel systems which are decoupled from axial forces can be used.

The form and embodiment of the configuration of the output interface 20c of the central shaft 20 with respect to the threaded spindle 6, 6′ (and/or adjuster shaft 5a, driver shaft 5′a) can be varied freely.

The form and embodiment of the fixing means 11g and 11k of the housing 11 can be varied freely.

The form and embodiment of the anti-twist fixing structure (anti-twist securing element 11j, spring fixing grooves 16b, assembly connection 17c, fixing projection 17d, securing groove 21c) can be varied freely.

### LIST OF DESIGNATIONS

1 Disc brake
2 Brake disc
3 Brake pad
3a Brake lining carrier
4 Brake caliper
5, 5′ Spindle unit
5a Adjuster shaft
5′a Driver shaft
5b Profile
5′c Axial groove
6, 6′ Threaded tube
6a, 6′a Pressure piece
7 Crossmember
8 Rotary lever
8a Actuator
8b Body
9 Drive
10 Adjusting device
11 Housing
11a Wall
11b, 11c Opening
11d Cover section
11e Bottom section
11f Wall opening
11g Caliper anti-twist fixing structure
11h Stop
   11i Guide groove
   11j Anti-twist securing element
11k Anti-twist fixing element
12 Axial bearing ball
13 Drive element
13a Operating lug
13b Axial bearing raceway
13c Overload ramp raceway
14 Overload ramp ball
15 Ball cage
16 Overload ramp element
16a Overload ramp raceway
16b Spring fixing groove
17 Overload spring unit
17a, 17b Spring
17c Assembly connection
17d Fixing projection
18 Radial freewheel
18a Freewheel axial bearing raceway
18b Freewheel spring
18c Profiling
18d Spring fixing groove
19 Freewheel ball
20 Central shaft
20a Drive section
20b Output section
20c Output interface
20d Adjusting interface
20e Guide section
20f Freewheel axial bearing raceway
20g Moment ramp section
20g′ Adjusting ramp
20g″ Application ramp
20h Freewheel toothing system
20i Sensor toothing system
20j Sealing ring groove
20k Output element
20l Output tongue
20m Output edge
21 Moment ramp disc
21a Moment ramp
21b Pressure side
21c Securing groove
21d Adjusting ramp
21e Application ramp
22 Application moment spring
23 Synchronizing device
23a, 23′a Synchronizing wheel
23b Synchronizer

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A wear adjustment device for adjusting friction face wear on a brake pad and a brake disc of a disc brake having a brake application device, the wear adjustment device being coupleable on a drive side to the brake application device and on an output side to a spindle unit of the disc brake, the wear adjustment device comprising:
a drive element;
in each case, one rolling body arrangement arranged axially on both sides of the drive element, of which rolling body arrangements one is configured as an anti-friction axial bearing and one is configured as a ball ramp coupling;
a central shaft which is coupled to the ball ramp coupling and has an output interface for coupling to the spindle unit;
a radial freewheel being coupled to the ball ramp coupling via an overload spring unit and to the central shaft;
a direction-dependent torque device; and
a housing, in which the drive element, the rolling body arrangements, the overload spring unit, the radial freewheel, the central shaft and the direction-dependent torque device are arranged.

2. The wear adjustment device according to claim 1, wherein direction-dependent torque device forms a vibration protection structure.

3. The wear adjustment device according to claim 2, wherein the wear adjustment device is configured by way of the direction-dependent torque device for discontinuous adjustment.

4. The wear adjustment device according to claim 1, wherein the wear adjustment device is configured by way of the direction-dependent torque device for discontinuous adjustment.

5. The wear adjustment device according to claim 1, wherein the direction-dependent torque device comprises:
a moment ramp section which is connected fixedly to the central shaft;
a moment ramp disc which is in engagement with the moment ramp section; and
an application moment spring which loads the moment ramp section and the moment ramp disc with an axial prestressing force which is fixable in advance.

6. The wear adjustment device according to claim 5, wherein the application moment spring is arranged between a bottom section of the housing and the moment ramp disc.

7. The wear adjustment device according to claim 6, wherein the direction-dependent torque device is configured with flat application ramps for adjustment and with adjusting ramps which are steep in relation to the flat application ramps for adjustment in a service case, which ramps are at least partially in contact.

8. The wear adjustment device according to claim 5, wherein the direction-dependent torque device is configured with flat application ramps for adjustment and with adjusting ramps which are steep in relation to the flat application ramps for adjustment in a service case, which ramps are at least partially in contact.

9. The wear adjustment device according to claim 1, wherein the axial bearing is formed from the drive element, axial bearing balls and a cover section of the housing.

10. The wear adjustment device according to claim 1, wherein the central shaft has a guide section which is fixed axially in the housing.

11. The wear adjustment device according to claim 10, wherein the axial bearing, the ball ramp coupling, the overload spring unit and the radial freewheel are arranged between the guide section and a cover section of the housing.

12. The wear adjustment device according to claim 1, wherein the radial freewheel is configured as a spring assembly and is in engagement with a freewheel toothing system of the central shaft.

13. The wear adjustment device according to claim 12, wherein the radial freewheel has radially stacked spring arms.

14. The wear adjustment device according to claim 1, wherein the housing is configured with at least one caliper anti-twist fixing structure and/or one anti-twist fixing element.

15. The wear adjustment device according to claim 1, wherein the ball ramp coupling has overload ramp balls which are positively guided in a ball cage and are arranged between the drive element and an overload ramp element.

16. The wear adjustment device according to claim 1, wherein the wear adjustment device is for a motor vehicle disc brake, in which the brake application device has a rotary lever, the wear adjustment device being coupled on the drive side to the roatary lever.

17. A disc brake having a brake disc, comprising:
a caliper configured to straddle the brake disc;
a brake application device arranged in the caliper, the brake application device including a rotary lever and at least one spindle unit;
a wear adjustment device coupleable on a drive side to the brake application device and on an output side to the spindle unit, the wear adjustment device comprising:
a drive element;
in each case, one rolling body arrangement arranged axially on both sides of the drive element, of which rolling body arrangements one is configured as an anti-friction axial bearing and one is configured as a ball ramp coupling;
a central shaft which is coupled to the ball ramp coupling and has an output interface for coupling to the spindle unit;
a radial freewheel being coupled to the ball ramp coupling via an overload spring unit and to the central shaft;
a direction-dependent torque device; and
a housing, in which the drive element, the rolling body arrangements, the overload spring unit, the radial freewheel, the central shaft and the direction-dependent torque device are arranged.

18. The disc brake according to claim 17, wherein the disc brake is a pneumatic disc brake.

19. The disc brake according to claim 17, wherein two spindle units are provided and the wear adjustment device is inserted onto or into one of the two spindle units; and
further wherein a synchronizing unit is configured to synchronize wear adjustment between the two spindle units.
